(19) United States
(12) Patent Application Publication
(10) Pub. No.: US 2002/0094895 A1
(43) Pub. Date: Jul. 18, 2002

(54) Closed-end washer

(76) Inventor: Tsan-Yao Hung, Tainan (TW)

Correspondence Address: RABIN & BERDO, P.C., 1101 14th Street, N.W., Suite 500, Washington, DC, 20005, US

(21) Appl. No.: 10/041,466

(22) Filed: Jan. 10, 2002

(30) Foreign Application Priority Data
Jan. 12, 2001 (TW) 90100805

(51) Int. Cl. F16H 55/36; F16H 55/12

(52) U.S. Cl. 474/151; 474/269

(57) ABSTRACT

A closed-end washer applied to a guide wheel device is coupled to a wheel axis and includes a roller, transmission belt and closed-end washer, wherein the wheel axis has a notch. In assembly, the roller is first put around the wheel axis. After the transmission belt is looped about the roller, the closed-end washer is embedded into the notch of the wheel axis for preventing the transmission belt and the roller from coming off the wheel axis during rotation. In practice, the closed-end washer is made of the flexible materials, such as rubber or plastic. The embedding pieces forms on the inner side of the closed-end washer is the embedding portion for embedding into the notch of the wheel axis so that the closed-end washer is securely placed on the wheel axis.

This application incorporates by reference Taiwanese application Serial No. 090100805, filed on Jan. 12, 2001.

### BACKGROUND OF THE INVENTION

1. Field of the Invention

The invention relates in general to a washer, and more particularly to a closed-end washer applied to a guide wheel device.

2. Description of the Related Art

High-tech industry promotes the development of the electrical industry in the recent years. Modem products, such as computers, computer peripheral, electric appliances, office appliances, or the like, make a mighty advance as compared with several years before. In respect of the image processing, the scanner nowadays is a crucial tool for digitizing an image. It is therefore easy to set up a website or make a digital photo album and other multimedia works by using scanners. The technique of manufacturing a scanner is ripe enough to lead to a keen competition in the market. In order to cater to the consumers' favor and earn more market share, it is a trend to aim at creating a scanner with a smaller size, high-efficiency, high-performance, and competitive price.

The operation principle of the scanner, simply stated, is to project the light on the document to be scanned and then the optical module receives the light reflected by the document to be scanned for sensing the image on it. The optical module moves step by step to complete sensing the image progressively. What follows in the passage is the explanation of the transmission apparatus of the optical module in the scanner.

Referring to FIG. 1, a transmission apparatus of an optical module is illustrated. The motor 170 drives the transmission belt 130 for advancing the optical module 100. The material of the transmission belt 130 can be a leather belt, chain, or rope. The transmission belt 130 is assembled around the guide wheel 180 to connect the optical module 100. When the motor 170 drives the transmission belt 130, the optical module 100 moves back and forth along a set path in the direction as the arrow signs shown in FIG. 1. The guide wheel 180 is the returning pivot of the transmission belt 130. The location of the guide wheel 180 is therefore fixed. In practice, a wheel axis can be first fixed at a proper position of the scanner and then the guide wheel 180 is coupled to and pivoted on the wheel axis. Besides, the guide wheel 180 may be a combination of a roller, roller cover, washer, and so on. The method of disposing the guide wheel 180 and its components is stated as follows.

Referring to FIG. 2A, a perspective view of a roller with a transmission belt is shown. The roller 210 is a hollow structure and the hollow part is for being coupled with the wheel axis. Besides, it requires a design for retaining two sides of the roller 210, such as the round plate 250 under the roller 210 in order to prevent the transmission belt 130 from deviating from the roller 210. Referring to FIG. 2B, a cross-sectional view of FIG. 2A along 2B-2B is shown. Before mounting the roller cover 310 on the roller 210, the transmission belt 130 is looped about the roller 210. After finishing the assembly, the transmission belt 130 can stick on the roller 210 tightly and be restricted by the roller 210 from coming off during the rotation of the roller 210. The roller 210 coupled with a roller cover 310 is shown in FIG. 3A and a cross-sectional view of the FIG. 3A along 3B-3B is shown in FIG. 3B.

Referring to FIG. 4A, a combination of a roller, transmission belt, roller cover, and shaft is shown. After putting the roller 210 around the wheel axis 410, the transmission belt 130 is looped about the roller 210 and the roller cover 310 is mounted on the roller 210. The roller 210 is therefore pivoted on the wheel axis 410. Although the roller cover 310 is designed for preventing the transmission belt 130 from deviation, the roller 210 with the roller cover 310 is easy to come off the wheel axis 410 as the transmission belt 130 is driven. Thus, a notch 420 is formed on the wheel axis 410 for placing a washer so that the washer can avoid the roller 210 from coming off.

Referring to FIG. 4B, a washer used for preventing the roller from coming off is shown. The washer 450 is embedded into the notch 420 and the roller 210 will not come off the wheel axis 410. The component such like the C-washer or E-ring, as shown in FIG. 5 and 6 respectively, can be used as the washer 450. FIG. 5 shows a perspective view of a C-washer. The C-washer 550 is generally made of a soft material. While coupling the C-washer 550 to the wheel axis 410, the inner ring of the C-washer 550 is easily embedded into the notch 420 by putting an external force since C-washer 550 has an opening. The C-washer 550 is then securely placed on the top section of the wheel axis 410 for preventing the roller 210 from coming off. The E-ring 650 in FIG. 6 can be coupled to the wheel axis 410 and the same purpose is achieved.

As mentioned above, the roller cover 310 is designed for preventing the transmission belt 130 from deviating from the roller 210 while the washer is used for preventing the roller 210 from coming off the wheel axis 410. As for the whole structure of the guide wheel 180, the effect of the roller cover 310 and the washer are closed. The roller cover 310 should be discarded for economizing the materials since the washer could also be used as a roller cover. Referring to FIG. 7A, a combination of a roller, transmission belt, wheel axis, and washer is shown. The C-washer 550 is supposed to keep the transmission belt 130 and the roller 210 from coming off. However, there still exist some problems with the combination in FIG. 7A. As shown in FIG. 7B, which is the perspective view of FIG. 7A, the C-washer 550 has an opening (the E-ring 650 has an opening as well). The transmission belt 130 usually gets stuck by the opening of the C-washer 550 during rotation and fails to run normally. It is therefore the guide wheel is designed to have both a roller cover and a washer for keeping the machine running well without malfunction caused by the transmission belt's being stuck. However, the wheel axis has to be longer that both the roller cover and the washer are coupled to the wheel axis. The above-mentioned structure of the guide wheel, which contradicts to the design principle for compactness, has to be improved.

The structure of traditional guide wheel at least has the following shortcomings: Firstly, it contradicts to the trend of compactness since the wheel axis gets longer so that both the roller cover and the washer are coupled to the wheel axis. Secondly, it requires both the roller cover and the washer at the same time, which wastes the materials.

### SUMMARY OF THE INVENTION

It is therefore an object of the invention to provide a closed-end washer, which is used as a roller cover of the guide wheel concurrently. It minimizes the volume of the guide wheel and economizes materials to raise the competitiveness of the product.

The invention achieves the above-identified objects by providing a closed-end washer for making up a guide wheel structure, which is characterized as follows:

The guide wheel device coupled to a wheel axis includes a roller, transmission belt, and closed-end washer, wherein the wheel axis has a notch. In assembly, the roller is first put around the wheel axis. After the transmission belt is looped about the roller, the closed-end washer is embedded into the notch of the wheel axis for preventing the transmission belt and the roller from coming off the wheel axis during rotation. In practice, the inner side of the closed-end washer is the embedding portion for embedding into the notch of the wheel axis so that the closed-end washer is securely placed on the wheel axis. The closed-end washer is made of the flexible materials, such as rubber or plastic. The embedding pieces radiated from the center of the closed-end washer are used as the embedding portion.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates a transmission apparatus of an optical module;

FIG. 2A shows a perspective view of a roller with a transmission belt;

FIG. 2B shows a cross-sectional view of FIG. 2A along 2B-2B;

FIG. 3A shows a perspective view of a roller in FIG. 2A, where the roller is coupled with a roller cover;

FIG. 3B shows a cross-sectional view of the FIG. 3A along 3B-3B;

FIG. 4A is a combination of a roller, transmission belt, roller cover and shaft;

FIG. 4B shows a washer used for preventing the roller from coming off;

FIG. 5 shows a perspective view of a C-washer;

FIG. 6 shows a perspective view of an E-ring;

FIG. 7A is a combination of a roller, transmission belt, shaft and washer;

FIG. 7B shows a perspective view of FIG. 7A;

FIG. 8A shows a top view of a closed-end washer according to a preferred embodiment of the invention;

FIG. 8B shows a top view of a closed-end washer according to an alternative preferred embodiment of the invention; and

FIG. 9 shows a perspective view of a guide wheel device using the closed-end washer in FIG. 8A.

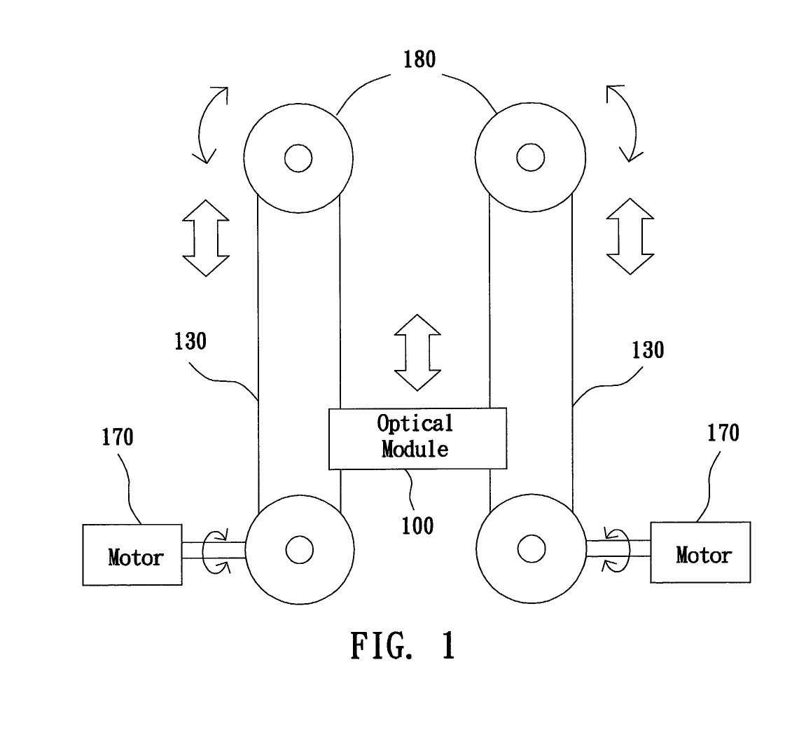

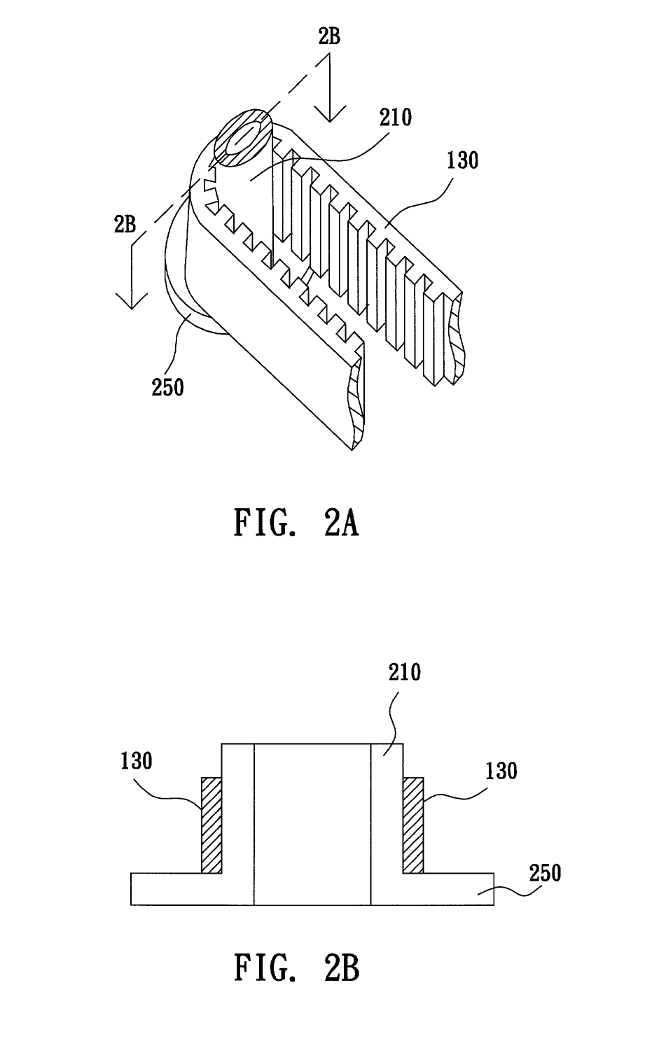

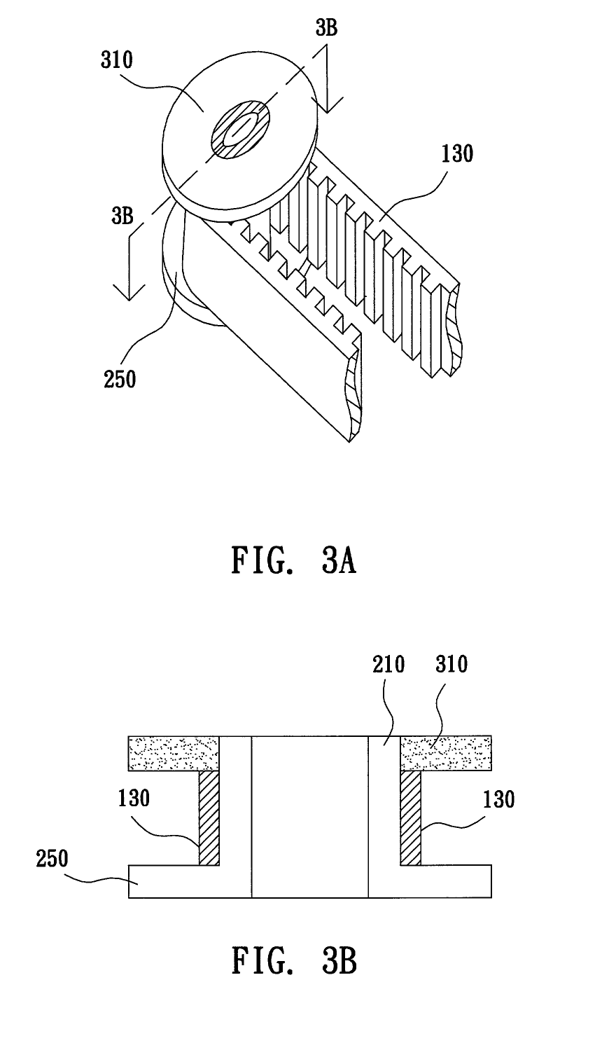

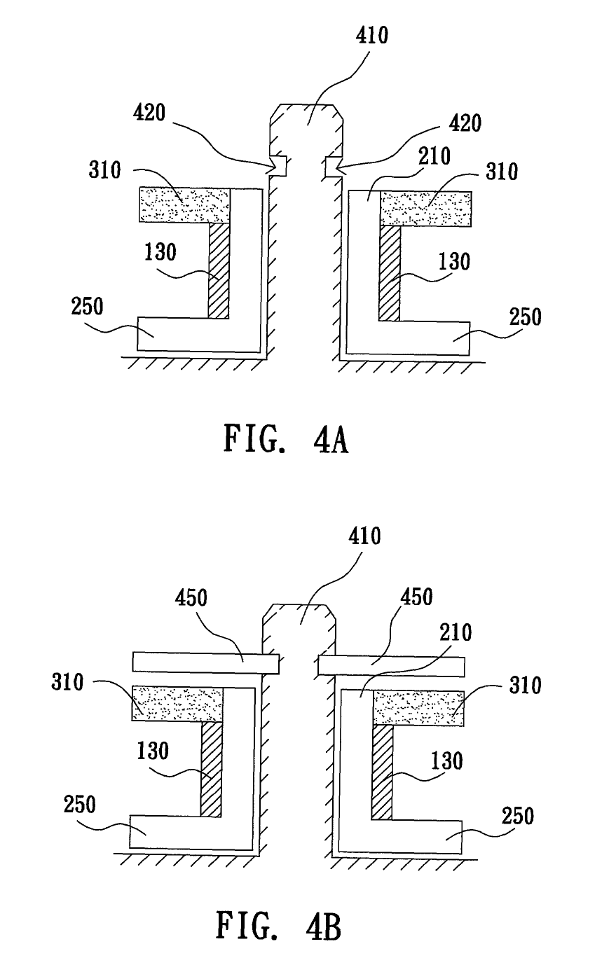

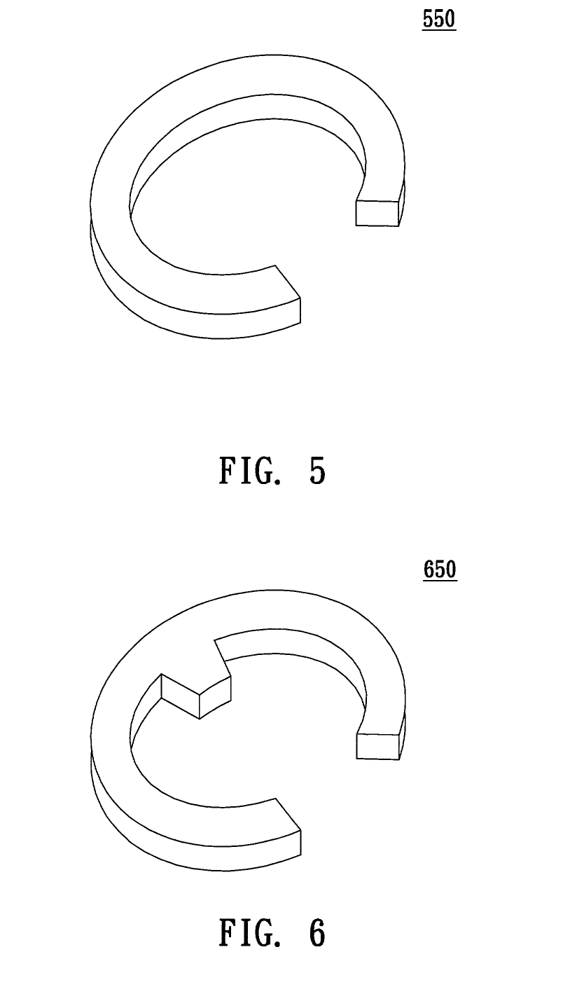

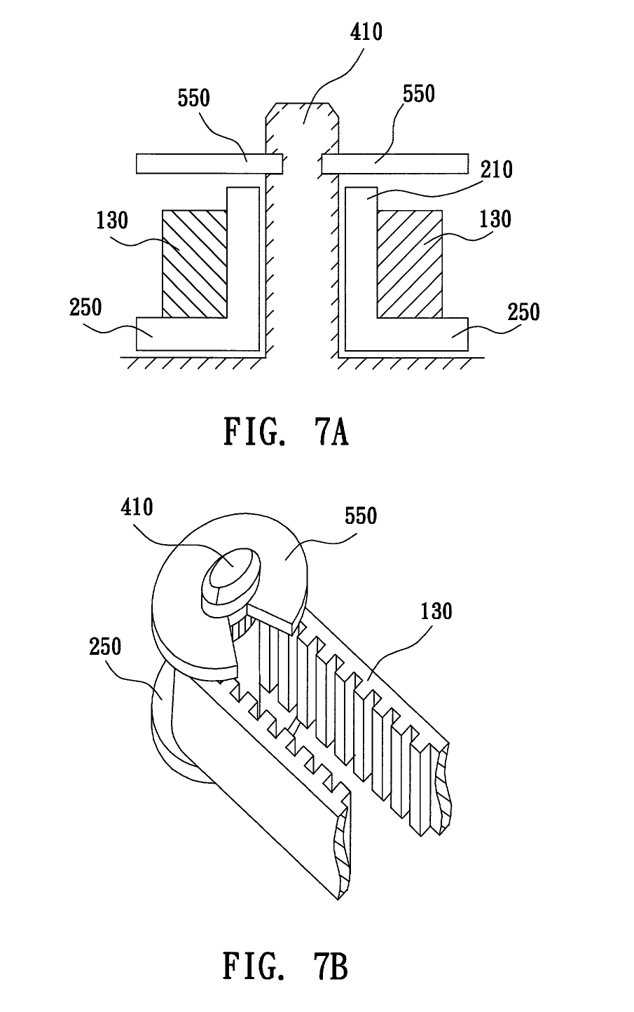

### DESCRIPTION OF THE PREFERRED EMBODIMENT

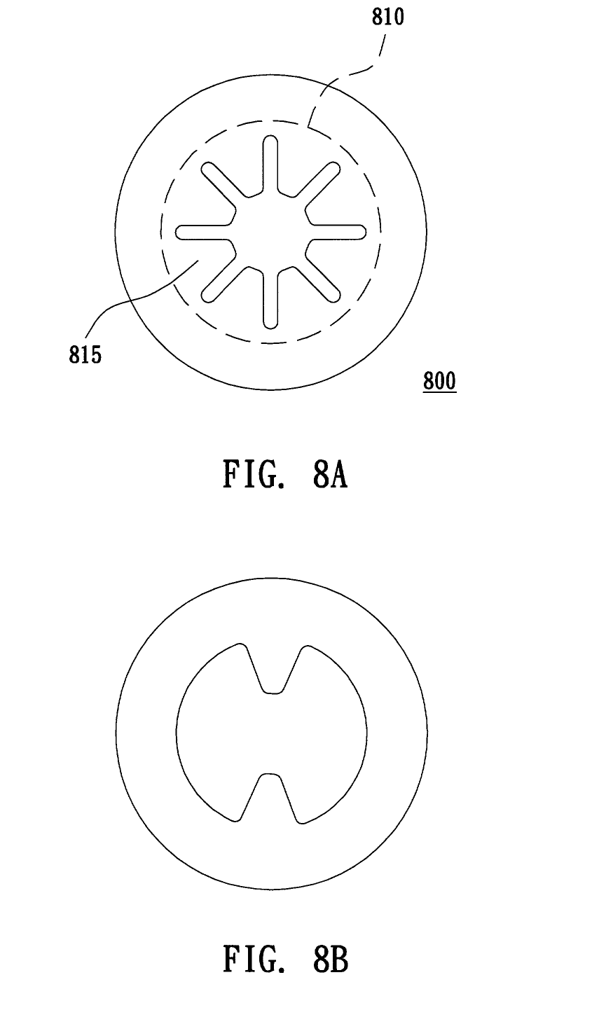

From the forgoing, it is apparently seen that the traditional guide wheel structure can not just discard the roller cover due to the opening of the C-washer or E-ring by which usually cause the transmission belt get stuck. Therefore the present invention provides a closed-end washer without an opening. Referring to FIG. 8A, a top view of a closed-end washer according to an alternative preferred embodiment of the invention is shown. The circumference of the closed-end washer 800 is complete as a whole. The inner side of the closed-end washer 800 is the embedding portion 810 for embedding into the notch of the wheel axis. The closed-end washer 800 is securely placed on the top section of the wheel axis. In order to embed the embedding portion 810 into the notch, the closed-end washer 800 is made of a flexible material in practice. In the present embodiment, the embedding portion 810 further comprises several embedding pieces 815 forming on the inner side of the closed-end washer 800. The embedding pieces 815 radiated from the center of the closed-end washer 800. Since the closed-end washer 800 is made of flexible material, the assembly of the closed-end washer 800 only requires placing the closed-end washer 800 on the top section of the wheel axis and pressing the closed-end washer 800 on the wheel axis for embedding the embedding pieces 815 into the notch of the wheel axis. Thus, the closed-end washer 800 can be placed on the wheel axis securely. There are also other flexible or elastic materials suitable for forming the closed-end washer 800, such like rubber, plastic or the like, without difficulty.

In addition, the embedding pieces 815 are used for embedding into the notch to fix the closed-end washer on the wheel axis regardless of the number of the embedding pieces. An alternative closed-end washer according to the invention is shown in FIG. 8B.

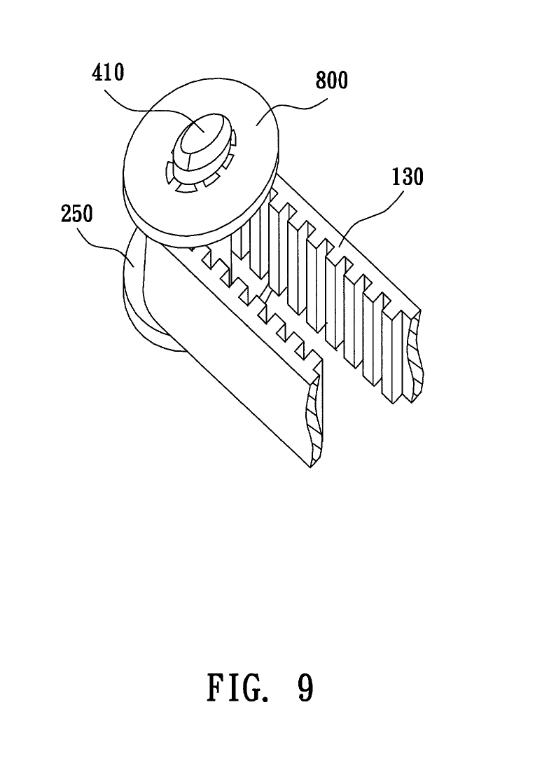

Referring to FIG. 9, a perspective view of a guide wheel device using the closed-end washer in FIG. 8A is shown. After putting the roller 210 around the wheel axis 410 and looping the transmission belt 130 about the roller 210, the closed-end washer 800 is embedded into the notch of the wheel axis 410. The assembly of the guide wheel device is then finished. The closed-end washer 800 positions the roller 210 and the transmission belt 130 and thus prevents the transmission belt 130 and the roller 210 from coming off the wheel axis 410 during rotation. The closed-end washer 800 with no opening will not cause the transmission belt 130 getting stuck even there is no roller cover.

What needs to be noticed, the closed-end washer applied to a guide wheel device is not restricted on the scanner. It is suitable for any device equipped a guide wheel device to minimize the volume of the guide wheel device and economize materials. The closed-end washer and the guide wheel device according to the invention at least have the following advantages: Firstly, the wheel axis is shorter than before and the product corresponds to the trend of compactness. Secondly, it does require the roller cover and therefore economize materials and raise the competitiveness of the product.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A closed-end washer for positioning a roller and a transmission belt, wherein the roller is pivoted on a wheel axis, the wheel axis having a notch and the transmission belt movably coupled with the roller, the closed-end washer comprising:
an embedding portion for embedding into the notch so that the closed-end washer is securely placed on the wheel axis, whereby the closed-end washer is securely placed on the wheel axis by the embedding portion in order to prevent the transmission belt and the roller from coming off the wheel axis during rotation after the transmission belt, roller, and wheel axis are coupled together.

2. The closed-end washer according to claim 1, wherein the transmission belt is a leather belt.

3. The closed-end washer according to claim 1, wherein the embedding portion further comprises a plurality of embedding pieces.

4. The closed-end washer according to claim 3, wherein the embedding pieces radiates from the center of the closed-end washer.

5. The closed-end washer according to claim 1, wherein the closed-end washer is made of a flexible material.

6. The closed-end washer according to claim 1, wherein the flexible material is rubber.

7. The closed-end washer according to claim 1, wherein the flexible material is plastic.

8. A guide wheel device coupled to a wheel axis, wherein the wheel axis having a notch, the guide wheel device comprising:
a transmission belt;
a roller pivoted on the wheel axis and movably coupled to the transmission belt; and
a closed-end washer having an embedding portion for embedding into the notch so that the closed-end washer is securely placed on the wheel axis, whereby the closed-end washer is securely placed on the wheel axis by the embedding portion in order to prevent the transmission belt and the roller from coming off the wheel axis during rotation after the transmission belt, roller, and wheel axis are coupled together.

9. The guide wheel device according to claim 8, wherein the transmission belt is a leather belt.

10. The guide wheel device according to claim 8, wherein the embedding portion further comprises a plurality of embedding pieces.

11. The guide wheel device according to claim 10, wherein the embedding pieces radiates from the center of the closed-end washer.

12. The guide wheel device according to claim 8, wherein the closed-end washer is made of a flexible material.

13. The guide wheel device according to claim 12, wherein the flexible material is rubber.

14. The guide wheel device according to claim 12, wherein the flexible material is plastic.

15. A transmission apparatus, comprising:
a wheel axis having a notch;
a roller pivoted on the wheel axis;
a transmission belt movably coupled to the roller, wherein the transmission belt drives the roller to rotate around the wheel axis; and
a closed-end washer embedded into the notch by the inner side of the closed-end washer so that the closed-end washer is securely placed on the wheel axis for preventing the transmission belt and the roller from coming off the wheel axis during rotation.

16. The transmission apparatus according to claim 15, wherein the inner side of the closed-end washer further comprises a plurality of embedding pieces for being embedded into the notch of the wheel axis.

17. The transmission apparatus according to claim 16, wherein the embedding pieces radiates from the center of the closed-end washer.

18. The transmission apparatus according to claim 15, wherein the closed-end washer is made of a flexible material.

19. The transmission apparatus according to claim 18, wherein the flexible material is rubber.

20. The transmission apparatus according to claim 18, wherein the flexible material is plastic.
